(19) United States
(12) Patent Application Publication
(10) Pub. No.: US 2021/0210300 A1
(43) Pub. Date: Jul. 8, 2021

(54) SURFACE-MOUNT TYPE MICRO FUSE

(71) Applicant: Conquer Electronics Co.,Ltd., New Taipei City (TW)

(72) Inventors: Hung-Chih CHIU, New Taipei City (TW); Po-Shuo CHIU, New Taipei City (TW)

(21) Appl. No.: 16/804,974

(22) Filed: Feb. 28, 2020

(30) Foreign Application Priority Data
Jan. 3, 2020 (TW) 109100242

(51) Int. Cl. H01H 85/041; H01H 85/055; H01H 85/165; H01H 71/08; H01H 85/18

(52) U.S. Cl. CPC H01H 85/0411; H01H 85/055; H01H 85/18; H01H 71/08; H01H 85/165

(57) ABSTRACT

A surface-mount type micro fuse has a fusible element provided in a housing. The fusible element has a fusible body and two intermediary portions connected to both ends of the fusing portion. Two gaps are formed respectively between the fusible body and the intermediary portions. When the fusible element is blown out due to the transient abnormal current, the gaps between the intermediary portions cause a large distance instantaneously to prevent the arc. Then effectively ensure the safety of the use of the overall circuit.

### CROSS-REFERENCE TO RELATED APPLICATIONS

This application is based upon and claims priority under 35 U.S.C. 119 from Taiwan Patent Application No. 109100242 filed on Jan. 3, 2020, which is hereby specifically incorporated herein by this reference thereto.

### BACKGROUND OF THE INVENTION

### 1. Field of the Invention

The present invention relates to a micro fuse, especially to a micro fuse formed with a surface-mount method.

### 2. Description of the Prior Arts

Fuses are mounted in the circuits for protection. The fuse has a fusible element to connect the protected circuit in series electrically. When the current in the circuit is abnormally increased and exceeds the rated current, the fusible element is blown due to overheating, thereby interrupting the circuit operation. Then the safety in using electricity is secured. When the fusible element is blown, the arc may be generated electric field penetrating the air that should have been an insulating medium because the electric field strength at both ends of the breakpoint is still very large. Therefore the circuit is not interrupted immediately, and the fuse loses its effect. In a prior art, an arc-extinguishing material may be disposed around the fusible element. The arc-extinguishing materials are used to reduce the probability of arcing of a fusible element by external influences or to eliminate the arc effect when an arc is generated quickly. However, when the electric field strength is extremely large, to eliminate the arc from outside cannot meet an urgency. As a result, the breaking of the fusible element cannot immediately constitute a circuit interruption.

### SUMMARY OF THE INVENTION

To overcome the shortcomings, the present invention provides a surface-mount type micro fuse to mitigate or to obviate the aforementioned problems.

A surface-mount type micro fuse has a fusible element provided in a housing. The fusible element has a fusible body and two intermediary portions connected to both ends of the fusing portion. Two gaps are formed respectively between the fusible body and the intermediary portions. When the fusible element is blown out due to the transient abnormal current, the gaps between the intermediary portions cause a large distance instantaneously to prevent the arc. Then effectively ensure the safety of the use of the overall circuit. Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a surface-mount type micro fuse in accordance with the present invention;

FIG. 2 is another perspective view of the micro fuse in FIG. 1;

FIG. 3 is a cross-sectional perspective view of the micro fuse in FIG. 1;

FIG. 4 is a top view of a fusible element of the micro fuse in FIG. 1;

FIG. 5 is a perspective view of another embodiment of a surface-mount type micro fuse in accordance with the present invention;

FIG. 6 is a cross sectional bottom view of the micro fuse in FIG. 1; and

FIG. 7 is an operational cross sectional bottom view of the micro fuse in FIG. 1, showing the fusible element blown.

### DETAILED DESCRIPTION OF THE EMBODIMENTS

With reference to the attached drawings, the present invention is described by means of the embodiment(s) below where the attached drawings are simplified for illustration purposes only to illustrate the structures or methods of the present invention by describing the relationships between the components and assembly in the present invention. Therefore, the components shown in the figures are not expressed with the actual numbers, actual shapes, actual dimensions, nor with the actual ratio. Some of the dimensions or dimension ratios have been enlarged or simplified to provide a better illustration. The actual numbers, actual shapes, or actual dimension ratios can be selectively designed and disposed, and the detail component layouts may be more complicated.

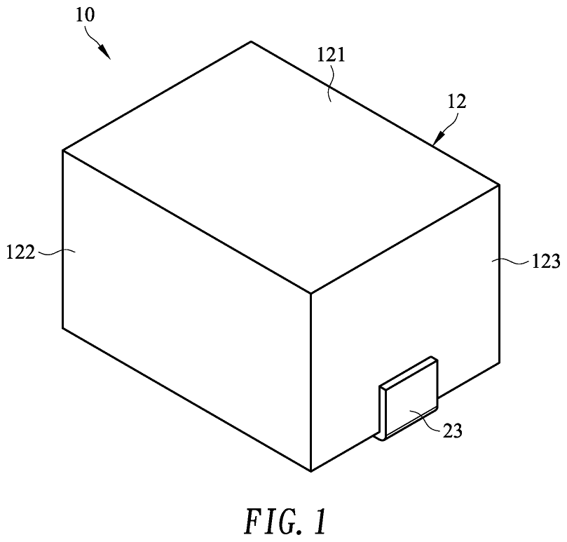

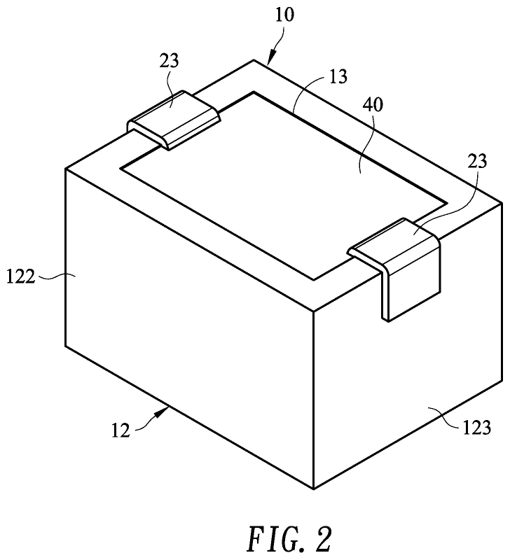

With reference to FIGS. 1 to 3, a micro fuse in accordance with the present invention comprises a housing 10, a fusible element 20, a first encapsulant 30, and a second encapsulant 40.

The housing 10 is hollow and has an inner space 11, an annular wall 12, and an opening 13. The annular wall 12 is disposed around the inner space 11 and includes a main wall 121, two sidewalls 122, and two end walls 123. The sidewalls 122 are disposed oppositely on two edges of the main wall 121. The end walls 123 are disposed oppositely on the other two edges of the main wall 121. The sidewalls 122 and the end walls are disposed around the sides of the inner space 11. The opening 13 communicates with the inner space 11 and is disposed between the edges of the sidewalls 122 and the end walls 123. In one embodiment, the housing 10 is made of ceramic.

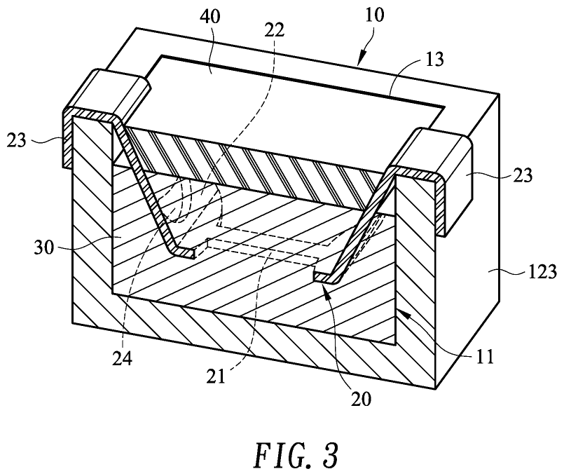

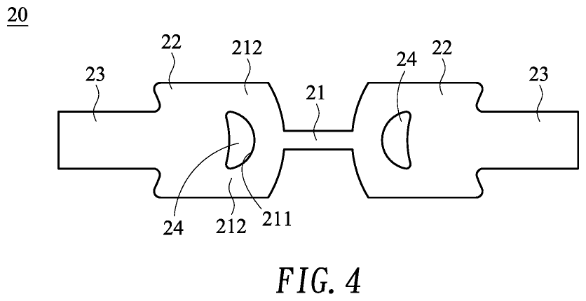

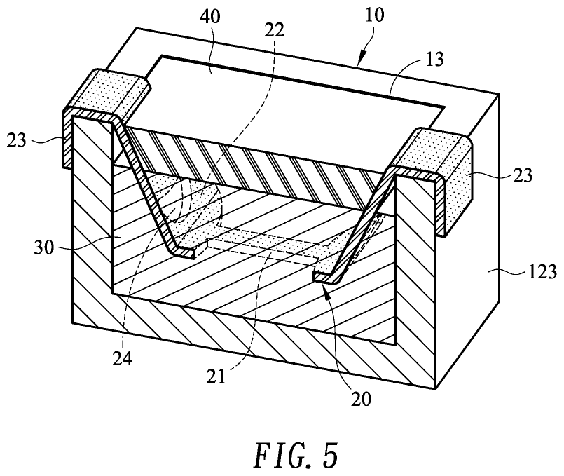

With reference to FIGS. 3 and 4, the fusible element 20 is mounted in the housing 10 and has a fusible body 21, two intermediary portions 22 and two conductive portions 23. The fusible body 21 is mounted in the inner space 11 of the housing 10. The intermediary portions 22 respectively connect to two ends of the fusible body 21. The conductive portions 23 respectively connect to an end of the intermediary portions 22, i.e. each intermediary portion 22 connecting between the fusible body 21 and one of the conductive portion 23. At least a part of each intermediary portion 22 is disposed in the inner space 11 of the housing 10. Each end of the fusible body 21 has a first segment 211 and at least one second segment 212. A gap 24 is formed between each first segment 211 of the fusible body 21 and a corresponding end of the corresponding intermediary portion 22 to disconnect the first segments 211 of the fusible body 21 from the intermediary portions 22. Each second segment 212 of the fusible body 21 connects to the corresponding end of the corresponding intermediary portion 22. In one embodiment, the fusible body 21 has two second segments 212 disposed respectively on two sides of the first segment 211. Thus, the two ends of the fusible body 21 are connected to the end surface of the intermediary portion 22 by the second segments 212 on both sides, and the first segment 211 located at the middle portion is separated from the intermediary portion 22 to form the gap 24. The conductive portions 23 extend out of the housing 10 through the opening 13 and are attached to the end walls 123 of the housing 10. In one embodiment, the intermediary portions 22 are inclined and are not perpendicular to the end walls 123 of the housing 10 so that the fusible body 21 is distant from the opening 13 of the housing 10. In one embodiment, the fusible element 20 may be integrally formed, or the fusible body 21 is made by different material. In another embodiment as shown in FIG. 5, a metal layer is plated on the fusible element 20. With the melting point of the metal layer lower than the melting point of the fusible element 20, the fusible body 21 starts to produce a fusing effect when the temperature is lower than the general condition. At this time, because the melting temperature is lower and the overall energy is smaller, the electric field strength is lower, and the probability of generating an arc is reduced.

With reference to FIG. 3, the first encapsulant 30 is filed in the inner space 11 of the housing 10 and covers the fusible body 21 and at least part of the intermediary portions 22. The first encapsulant 30 has the characteristics of flame retardancy and arc extinguishing. In one embodiment, the first encapsulant 30 may be made of quartz sand, explosion-proof sand, or a mixture of a flame retardant and epoxy resin. The flame retardant may be melamine, magnesium hydroxide, aluminum hydroxide, and other materials.

The second encapsulant 40 is mounted on the opening 13 of the housing 10 to block the contact between the first encapsulant 30 and the outside environment. The second encapsulant 40 and the first encapsulant 30 are made of different materials. The second encapsulant 40 has heat resistance characteristics. In one embodiment, the second encapsulant 40 may be made of silicon, polyimide (PI), or other materials.

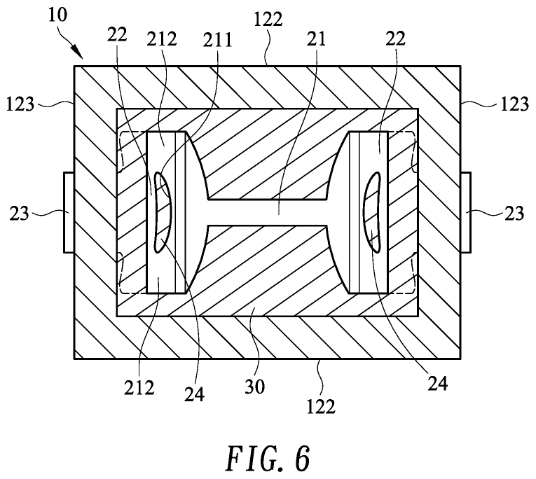

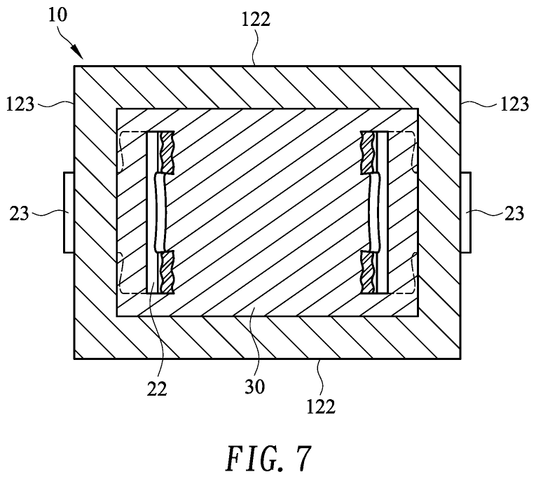

With reference to FIGS. 6 and 7, the fusible body 21 of the fusible element 20 keeps its integrity, so that the connected circuits maintain normal operation when the normally used. However, when the current increases abnormally and exceeds the rated current, the fusible body 21 of the fusible element 20 is overheated and blows. At the time of fusing, in addition to the distance between the two intermediary portions 22 due to fusing of the fusible body 21, the distance between the two intermediary portions 22 is instantly increased because of the gaps 24 between the first segments 211 of the fusible body 21 and the intermediary portions 22. The increasing of the distance lowers the chance of arcing. Thus, the structure of the fusible element 20 itself stops the arc from generating. In addition, the flame that may be caused by the instantaneous high heat is effectively prevented by the first encapsulant 30 from generating a burning phenomenon.

In conclusion, the advantage of the present invention is to prevent the arc at the first moment by the structural characteristics of the fusible element 20 itself when the conductive fuse 20 is blown out due to excessive current. Moreover, with the first encapsulant 30 having a characteristic of arc extinguishing, the first encapsulant 30 also can keep the arc from generating to achieve the effect of protecting the circuit.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A surface-mount type micro fuse comprising:
a housing having an inner space;
a fusible element mounted in the housing and having
a fusible body mounted in the inner space of the housing and having
two ends, and each end having a first segment and two second segments; and
a middle part connecting the first segments of the ends and being thinner than the first segments;
two conductive portions extending out of the housing; and
two intermediary portions formed respectively between the conductive portions and the fusible body, wherein a gap is formed between the first segment of each end of the fusible body and a corresponding intermediary portion, and each second segment of the fusible body connects to the corresponding intermediary portion, and the gap is coaxial with the middle part of the fusible body; and
a first encapsulant made of flame retardant material, filled in the inner space of the housing, and covering the fusible body and at least part of the intermediary portions of the fusible element.

2. The micro fuse as claimed in claim 1, wherein the two second segments respectively disposed on two sides of the first segment on the same end.

3. The micro fuse as claimed in claim 1, wherein
the housing has
an annular wall disposed around the inner space and having two end walls opposite to each other; and
an opening formed on the housing and communicating with the inner space; and
the conductive portions extends out of the housing from the opening and are respectively attached to the end walls of the housing.

4. The micro fuse as claimed in claim 2, wherein
the housing has
an annular wall disposed around the inner space and having two end walls opposite to each other; and
an opening formed on the housing and communicating with the inner space; and
the conductive portions extends out of the housing from the opening and are respectively attached to the end walls of the housing.

5. The micro fuse as claimed in claim 3 further comprising a second encapsulant made of heat resistance material and sealing the opening of the housing, wherein the second encapsulant and the first encapsulant are made of different materials.

6. The micro fuse as claimed in claim 4 further comprising a second encapsulant made of heat resistance material and sealing the opening of the housing, wherein the second encapsulant and the first encapsulant are made of different materials.

7. The micro fuse as claimed in claim 3, wherein the intermediary portions are not parallel to the end walls of the housing, so that the fusible body is distant from the opening of the housing.

8. The micro fuse as claimed in claim 4, wherein the intermediary portions are not parallel to the end walls of the housing, so that the fusible body is distant from the opening of the housing.

9. The micro fuse as claimed in claim 1, wherein the first encapsulant is made of a quartz sand, an explosion-proof sand, or a mixture of a flame retardant and an epoxy resin.

10. The micro fuse as claimed in claim 2, wherein the first encapsulant is made of quartz sand, explosion-proof sand, or a mixture of a flame retardant and an epoxy resin.

11. The micro fuse as claimed in claim 9, wherein the flame retardant is melamine, magnesium hydroxide, or aluminum hydroxide.

12. The micro fuse as claimed in claim 10, wherein the flame retardant is melamine, magnesium hydroxide, or aluminum hydroxide.

13. The micro fuse as claimed in claim 5, wherein the second encapsulant is made of silicone or polyimide.

14. The micro fuse as claimed in claim 6, wherein the second encapsulant is made of silicone or polyimide.

15. The micro fuse as claimed in claim 1 further comprising a metal layer plated on the fusible element, wherein a melting point of the metal layer is lower than a melting point of the fusible element.

16. The micro fuse as claimed in claim 2 further comprising a metal layer plated on the fusible element, wherein a melting point of the metal layer is lower than a melting point of the fusible element.

17. The micro fuse as claimed in claim 1, wherein
the fusible body of the fusible element is made of a first material;
the intermediary portions and the conductive portions of the fusible element are made of a second material; and
the first material is different to the second material.

18. The micro fuse as claimed in claim 2, wherein
the fusible body of the fusible element is made of a first material;
the intermediary portions and the conductive portions of the fusible element are made of a second material; and
the first material is different to the second material.
